(19) United States
(12) Patent Application Publication
(10) Pub. No.: US 2014/0362051 A1
(43) Pub. Date: Dec. 11, 2014

(54) CONTACTLESS USER INTERFACE

(71) Applicants: Jean-Yves Gomez, Grenoble (FR); Laurent Jamet, Grenoble (FR); Emmanuel Guerineau, Grenoble (FR); Christophe Premont, Grenoble (FR)

(72) Inventors: Jean-Yves Gomez, Grenoble (FR); Laurent Jamet, Grenoble (FR); Emmanuel Guerineau, Grenoble (FR); Christophe Premont, Grenoble (FR)

(73) Assignees: Commissariat à L'énergie Atomique et aux énergies Alternatives, Paris (FR); ISORG, Grenoble (FR)

(21) Appl. No.: 14/347,982

(22) PCT Filed: Aug. 8, 2012
(86) PCT No.: PCT/FR2012/051863

§ 371 Date: Jul. 14, 2014

(30) Foreign Application Priority Data
Sep. 27, 2011 (FR) 1158607

(51) Int. Cl. G06F 3/042

(52) U.S. Cl. CPC G06F 3/0421; G06F 2203/04108
USPC 345/175

(57) ABSTRACT

The invention relates to a user interface device (10) comprising a matrix of photon sensors (12), adapted for detecting variations in the shadow of an actuation member (16) and for deducing therefrom an item of information representative of a variation of position of the actuation member.

### BACKGROUND

The present disclosure relates to a user interface device, or man-machine interface.

### DISCUSSION OF THE RELATED ART

User interface devices controllable by simple sliding of a finger or of the hand on a touch-sensitive surface, or touch surface, have already been provided. The touch surface may be superimposed over a display, which enables to form an interactive user interface, or touch screen.

Touch screens and surfaces are currently used in many fields. As an example, they have already been used to control cell phones, computers, television sets, motor vehicles, ticket vending machines, industrial equipment, medical equipment, etc.

A disadvantage of this type of interface is that the contact with the users' fingers tends to rapidly get the touch surface dirty. This implies the necessity to provide a regular cleaning, in particular in case of use in dirty environments (factories, public transports, etc.). Touch surfaces further raise a hygiene issue, in particular in hospitals where they may be a disease transmission vector. Further, the operation of touch surfaces is generally degraded when the user is wearing gloves. This may be a problem in certain fields of application (industry, surgery, outdoor use by cold weather, ticket vending machines for ski resorts, etc.).

Patent application US20080297487 describes the use of one or a plurality of proximity sensors in combination with a touch screen, to detect events such as the passing of an actuating element (finger, hand, object, etc.) above the screen. This enables the user to perform certain actions without having to touch the touch surface. The proximity sensors described in said document comprise at least one infrared emitter and at least one infrared receiver. In operation, the sensor permanently emits an infrared radiation. When a finger, a hand, or an object passes close to the sensor, part of the emitted infrared radiation is reflected towards the receiver, and the sensor deduces therefrom information relative to the presence of an object close to the touch surface.

A disadvantage of this type of device is that the emission of the infrared radiation by the proximity sensors causes an unwanted power overconsumption.

It would be desirable to have a contactless user interface device capable of operating without emitting any radiation.

Further, touch surfaces, touch screens, and proximity sensors of the above-mentioned type are relatively complex to form.

It would be desirable to be able to more easily form touch and contactless surfaces and screens. It would further be desirable to be able to form such devices on all types of support and in particular on flexible supports such as plastic, paper, cardboard, or fabric, on large supports (advertisement panels), or on disposable supports such as packages of convenience goods.

It has already been provided to form electronic components, such as transistors, light-emitting diodes, and photodetectors, based on organic conductive and semiconductive materials. Such materials have the advantage of being easier to deposit and less fragile than inorganic conductive and semiconductive materials (for example, silicon) used in conventional technological processes.

The forming of organic semiconductor components however remains rather complex. In particular, it is necessary to provide low-pressure vapor deposition phases and anneal phases at relatively high temperatures, for example, higher than 250° C. As a result, such components can only be formed of particularly robust supports, and by means of relatively expensive equipment. Further, the juxtaposing of such components on large surface areas is difficult since it is difficult (or too expensive) for deposition equipment to treat supports of large dimensions (for example, having a diameter greater than 30 cm).

It would further be desirable, for example, in the field of advertising or communication, to be able to form a display surface capable of displaying an animation and offering possibilities of interaction with a user.

### SUMMARY

Thus, an object of an embodiment of the present invention is to provide a user interface device overcoming at least some of the disadvantages of existing devices.

According to a first aspect, an object of an embodiment of the present invention is to provide a user interface device capable of being actuated without any contact with the user.

Another object of an embodiment of the present invention is to provide a contactless user interface device capable of operating without emitting any radiation.

According to a second aspect, an object of an embodiment of the present invention is to provide a user interface device based on organic conductive and semiconductor materials.

Another object of an embodiment of the present invention is to provide a user interface device which is easier to manufacture than existing devices.

Another object of an embodiment of the present invention is to provide a user interface device capable of being formed on a greater variety of supports than current devices, and particularly on low-cost supports such as plastic, paper, fabric, etc.

According to a third aspect, an object of an embodiment of the present invention is to provide an interactive user interface device capable of being used for advertising or communication purposes.

Thus, an embodiment of the present invention provides a user interface device comprising an array of photon sensors, capable of detecting variations of the shadow of an actuating element and of deducing therefrom information representative of a position variation of the actuating element.

According to an embodiment of the present invention, the device is capable of deducing from the shadow variations information representative of a distance variation between the actuating element and the array of sensors.

According to an embodiment of the present invention, the device is capable of detecting variations of the light intensity level received by the sensors, and of deducing therefrom information representative of a distance variation between the actuating element and the sensor array.

According to an embodiment of the present invention, the device is capable of deducing from the shadow variations information representative of a variation of the position of the actuating element parallel to the sensor array.

According to an embodiment of the present invention, the device comprises no optical system between the sensor array and the actuating element.

According to an embodiment of the present invention, a translucent protection layer coats the sensor array.

According to an embodiment of the present invention, the surface area of the sensor array is larger than the surface area of the actuating element opposite to said array.

According to an embodiment of the present invention, the actuating element is at a distance greater than ten centimeters away from the sensor array.

According to an embodiment of the present invention, this device further comprises an array of light display pixels.

According to an embodiment of the present invention, the photons sensors are made of transparent materials.

According to an embodiment of the present invention, the device further comprises an array of infrared emitters.

According to an embodiment of the present invention, the device further comprises a darkness sensor and means for activating the infrared emitters when the brightness is lower than a threshold.

According to an embodiment of the present invention, the photon sensors are organic sensors formed by deposition of organic conductive and semiconductive materials in liquid form on a dielectric support.

According to an embodiment of the present invention, the dielectric support is made of a material from the group comprising glass, plastic, paper, cardboard, and fabric.

Another embodiment of the present invention provides an interactive display surface comprising a user interface device of the above-mentioned type, and display means formed by deposition of organic conductive and semiconductive materials in liquid form on the dielectric support.

Another embodiment of the present invention provides a method of manufacturing a user interface device of the above-mentioned type, wherein the sensors are formed at a temperature smaller than 150° C. and at the atmospheric pressure.

### BRIEF DESCRIPTION OF THE DRAWINGS

The foregoing and other features and advantages will be discussed in detail in the following non-limiting description of specific embodiments in connection with the accompanying drawings, among which:

FIG. 1 is a perspective view schematically showing an embodiment of a user interface device;

FIG. 2 is a cross-section view of the user interface device of FIG. 1;

FIG. 3 is a perspective view schematically showing an alternative embodiment of a user interface device;

FIG. 4 is a cross-section view showing another alternative embodiment of a user interface device;

FIGS. 5A and 5B are cross-section views schematically and partially showing an embodiment of a user interface device based on organic conductive and semiconductive materials;

FIG. 6 is a cross-section view schematically and partially showing an alternative embodiment of the device of FIGS. 5A and 5B; and

FIG. 7 schematically shows an embodiment of an interactive display surface capable of being used for advertising purposes.

### DETAILED DESCRIPTION

For clarity, the same elements have been designated with the same reference numerals in the various drawings and, further, as usual in the representation of integrated circuits, the various drawings are not to scale. Further, only those elements which are useful to the understanding of the present invention have been shown and will be described. In particular, what use is made of the user interface devices described hereafter has not been detailed. It will be within the abilities of those skilled in the art to use the provided devices in any type of system capable of being controlled via a touch and/or contactless interface. Further, the means for processing the information provided by the user interface devices described hereafter and the means of connection with the system(s) to be controlled are within the abilities of those skilled in the art and will not be described.

A first aspect of an embodiment of the present invention provides a user interface device capable of detecting variations of the shadow of an actuating element on an array of photons sensors, or photodetectors, and of deducing therefrom information representative of a position variation of the actuating element.

It should be noted that position of the actuating element here means a position relative to the interface device. A usage mode where the user interface device itself is displaced, the actuating element remaining fixed, may in particular be provided.

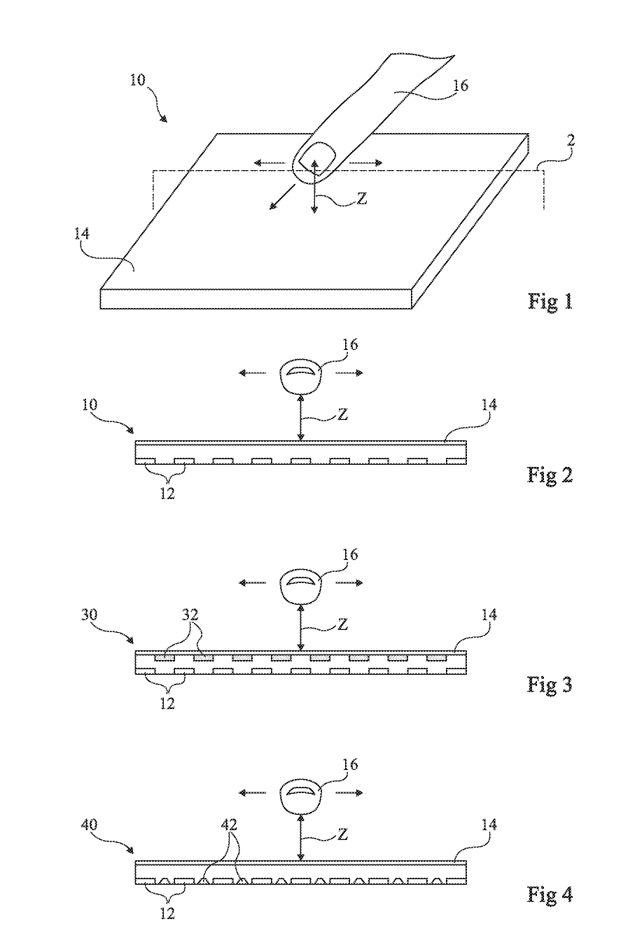

FIGS. 1 and 2 schematically show an embodiment of a user interface device 10. FIG. 1 is a perspective view of device 10, and FIG. 2 is a cross-section view along plane 2 of FIG. 1.

Device 10 comprises an array of photon sensors or photodetectors 12 (FIG. 2). In this example, sensors 12 are arranged on a planar surface. Embodiments may however be provided where sensors 12 are arranged on a non-planar surface. Sensor array 12 may be topped with a transparent or translucent protection coating 14, for example, a glass plate or a plastic coating.

Device 10 is capable of detecting variations of the cast shadow of an actuating element 16 on sensor array 12, when the actuating element is located between a light source and the array.

Actuating element 16 may be the user's finger, hand, or any other object. The light source is preferably ambient light, for example, the sun or the indoor electric lighting of a room in a building.

In this example, actuating element 16 is placed directly opposite to sensor array 12, that is, no optical system is provided between the array and the actuating element. The surface area taken up by the sensor array is preferably greater than the surface area of the projection of the actuating element on the plane of this array. More generally (in particular, if sensor array 12 does not occupy a planar surface), the surface area of sensor array 12 is greater than the surface area of the actuating element opposite to this array.

In a preferred embodiment, device 10 is capable of detecting displacements of the actuating element in a plane parallel to the plane of sensor array 12, and variations of distance Z between the actuating element and sensor array 12.

For this purpose, in an initialization phase, device 10 measures the ambient brightness, that is, the light intensity received by each sensor 12 when no actuating element is placed opposite to sensor array 12.

When actuating element 16 is placed between the light source and the sensor array, the cast shadow of the actuating element on the sensor array decreases the light intensity received by some of sensors 12. This enables device 10 to detect the presence of actuating element 16 in the vicinity of the array and, possibly, to follow the displacements of the actuating element in a plane parallel to the plane of the array (or parallel to the surface area taken up by the array if this surface is not planar).

When distance Z between the actuating element and sensor array 12 varies, the light intensity level received by sensors 12 also varies. In particular, when actuating element 16 is brought closer to sensor array 12, the light intensity received by sensors 12 in the shade of the actuating element decreases, and when actuating element 16 is drawn away from the sensor array, the light intensity increases. Device 10 is capable of deducing, from intensity variations of the cast shadow of the actuating element, information relative to the variations of distance Z between the actuating element and the sensor array. In an alternative embodiment, a calibration phase creating a correspondence between the intensity level of the cast shadow of the actuating element and the distance between actuating element and sensors 12 may be provided. This enables device 10 to measure distance Z between the actuating element and sensors 12.

Thus, in a preferred embodiment, device 10 is capable of detecting the position in three dimensions of actuating element 16 in the space located opposite to the sensor array.

Although this has not been shown in the drawings, device 10 may comprise means for processing the signals delivered by sensors 12 (for example, a microprocessor), and means of communication with a device or a system to be controlled (wire or wireless link).

Further, and although this has not been shown, each photodetector 12 may comprise a focusing lens, for example, a Fresnel lens. A lens array also forms an interface between the photosensitive region of photodetector array 12 and coating 14, or is integrated to coating 14. The provision of lenses enables to improve the lateral resolution of detection of the actuating element, particularly when it is remote from device 10.

An advantage of interface device 10 described in relation with FIGS. 1 and 2 is that it is capable of being actuated without any contact with the user. It should however be noted that device 10 may also operate as a touch surface, that is, if the user slides his finger on the upper surface of the device (upper surface of protection coating 14 in this example), the device will be capable of determining the position in two dimensions of the actuating element on the sliding surface (distance Z equal to the thickness of protection coating 14).

Another advantage of interface device 10 is that it enables to provide information relative to the distance between the actuating element and sensors 12. This for example enables to implement applications for the control of three-dimensional virtual objects, or three-dimensional navigation.

Another advantage of interface device 10 is that it does not require, in order to operate, the emission of an infrared radiation or other, which enables to minimize its electric power consumption.

In the above-described embodiment, the shadow of the actuating element, cast on the detection surface, is used to obtain information relative to the position of the actuating element. The image of the actuating element, seen by the photon sensors, may also be used. It should be noted that in practice, the cast shadow and the image of the actuating element do not coincide, except if the light source is placed exactly in the axis of the projection of the actuating element on the sensor array. As a variation, device 10 may detect both the cast shadow and the image of the actuating element to obtain more accurate information relative to the position or to the position variations of the actuating element. Device 10 for example comprises software for processing the signals delivered by the photodetector array, capable of detecting the cast shadow and possibly the image of the actuating element.

In a preferred embodiment, device 10 is capable of operating (that is, of detecting the cast shadow of the actuating element) when actuating element 16 is located at a distance greater than 10 cm away from the sensor array, for example, a distance in the range from 10 cm to 1 m.

FIG. 3 is a cross-section view showing an alternative embodiment where a user interface device 30 comprises a display screen, to form an interactive interface.

Device 30 of FIG. 3 comprises the same elements as device 10 of FIGS. 1 and 2, and further comprises an array 32 of light display (or backlighting) pixels. In this example, pixels 32, for example, light-emitting diodes, are arranged in a plane parallel to photodetector array 12, and between the photodetector array and protection coating 14. Photodetector array 12 and pixel array 32 are stacked with a slight offset so that, in top view, pixels 32 do not face sensors 12, which would mask sensors 12 and would prevent the detection of the cast shadow of the actuating element.

In an alternative embodiment, photon pixel array 12 is placed between display pixel array 32 and protection coating 14. In this case, stacked 12 and pixels 32 may be stacked with no offset, provided for sensors 12 to be made of transparent or translucent materials.

In another alternative embodiment, the detection and display arrays are not stacked, but are made in a same level of the stack of conductive and semiconductive arrays (alternation of pixels 32 and of sensors 12).

It should be noted that the display screen associated with interface device 30 is not necessarily a light-emitting diode display, but may also be formed with any other adapted technology.

Further, in another alternative embodiment, instead of being stacked to the user interface device, the display screen is separate and connected to the interface device by a wire or wireless link.

FIG. 4 is a cross-section view showing another alternative embodiment where a user interface device 40 comprises infrared proximity detectors. Device 40 of FIG. 4 comprises the same elements as device 10 of FIGS. 1 and 2, and further comprises an infrared emitter array 42. In operation, each of emitters 42 permanently emits an infrared radiation. When actuating element 16 passes over an emitter 42, part of the emitted radiation is reflected towards a neighboring photodetector 12, which can deduce information relative to the presence of an object above the interface. Thus, infrared detectors 42, in combination with photodetectors 12, enables device 40 to implement the same functions of detection of the position variations of actuating element 16 as photodetectors 12 alone used as shade detectors.

An advantage of infrared detection over shade detection is that its operation is independent from the ambient lighting and thus more robust. In particular, infrared detection may operate in the dark, in the absence of any external light source. It may be provided to alternate between a low-consumption operating mode, based on the detection of the cast shadow of the actuating element by photodetectors 12 when the ambient lighting allows it, and an infrared operating mode when the lighting conditions do not allow the cast shadow detection.

A darkness sensor may for example be provided to automatically switch from the low-consumption mode to the infrared mode when the ambient luminosity becomes too low to allow the cast shadow detection.

An infrared emission (by emitters 42) with a frequency modulation may be provided, which enables, on reception by photodetectors 12, to discriminate shade from infrared. This enables to simultaneously use the infrared operation and the cast shadow detection operation to obtain more accurate information relative to the position of the actuating element.

The infrared emission with a frequency modulation further enables to decrease the power consumption of the infrared source.

As in the example described in relation with FIG. 3, interface device 40 may be associated with a display screen, not shown in FIG. 4.

According to a second aspect of an embodiment of the present invention, a user interface device based on organic conductive and semiconductive materials is formed.

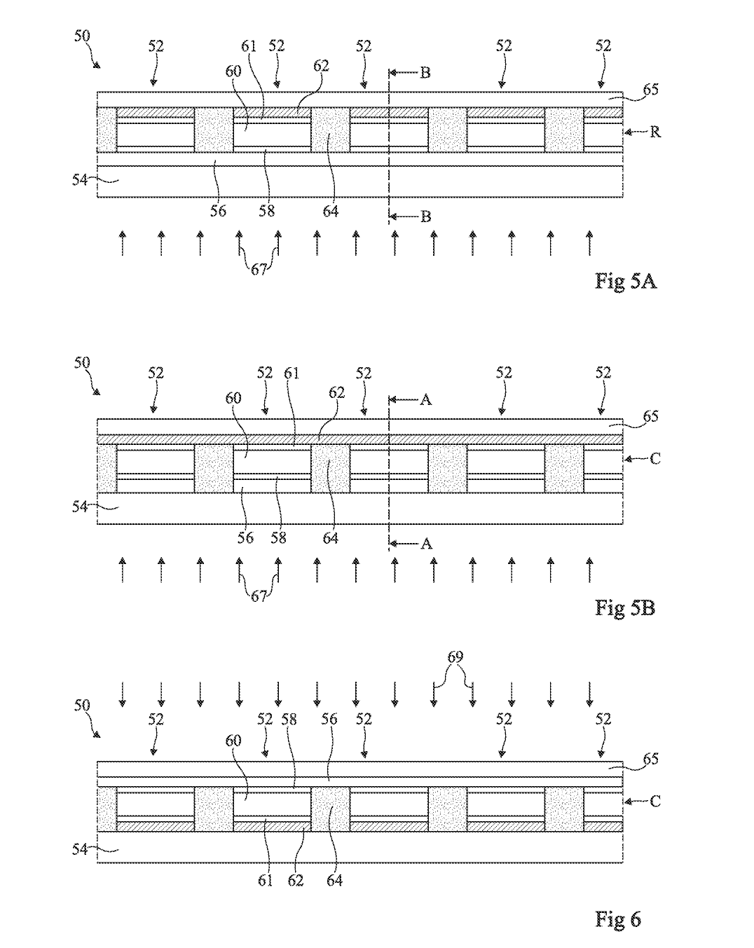

FIGS. 5A and 5B are cross-section views schematically and partially showing an embodiment of a user interface device 50 based on organic conductive and semiconductive materials. FIG. 5B is a cross-section view in plane B of FIG. 5A, and FIG. 5A is a cross-section view in plane A of FIG. 5B.

Device 50 comprises an array of photon sensors, or photodetectors 52, preferably capable of detecting variations of the cast shadow of an actuating element (not shown in FIGS. 5A and 5B). In this example, photodetectors 52 are formed on a surface of a transparent or translucent dielectric substrate or support 54, for example, made of glass or plastic. Each photodetector 52 comprises a stack comprising, in the following order from substrate 54: a transparent electrode 56, for example, made of indiumtin oxide (ITO); a layer 58 of a heavily-doped transparent organic semiconductor polymer (electron donor layer), for example, a polymer known as PEDOT:PSS, which is a mixture of poly(3,4)-ethylenedioxythiophene and of polystyrene sodium sulfonate; a layer 60 made of an organic semiconductor polymer, for example, poly(3-hexylthiophene) or poly(3-hexylthiophene-2,5-diyl) (P-type semiconductor), known as P3HT, or [6,6]-phenyl-C₆₁-methyl butanoate (N-type semiconductor), known as PCBM; a layer 61 made of a heavily-doped organic semiconductor polymer (hole donor layer); and an electrode 62, for example, made of aluminum or silver. Lower electrodes 56 have, in top view, the shape of parallel strips, each strip 56 addressing all the photodetectors of a same row R (FIG. 5A) of the array. Upper electrodes 62 have, in top view, the shape of strips orthogonal to electrodes 56, each strip 62 addressing all the photodetectors of a same column C (FIG. 5B) of the array. In this example, lower electrode layer 56 extends continuously under each row R of photodetectors 52 of the array, and upper electrode layer 62 extends continuously on each column C of photodetectors 52 of the array. Laterally, semiconductor regions 60 of photodetectors 52 are separated from one another by a dielectric material 64. Further, a transparent protection coating 65 covers the upper surface of the array (side of electrodes 62).

In this example, photodetectors 52 are intended to be illuminated through transparent substrate 54 (and through transparent layers 56 and 58). In FIGS. 5A and 5B, the incident radiation is shown by arrows 67, on the side of substrate 54.

FIG. 6 is a cross-section view schematically and partially showing an alternative embodiment of device 50 of FIGS. 5A and 5B. The device of FIG. 6 differs from the device of FIGS. 5A and 5B in that the order of photodetector layers 52 is inverted. FIG. 6 is a cross-section view along a column C of photodetectors. The corresponding cross-section (along a row) has not been shown.

In this example, each photodetector 52 comprises a stack comprising, in the following order from substrate 54, an electrode 62, for example, made of aluminum or of silver, a layer 61 made of a heavily-doped organic semiconductor polymer (hole donor layer), a layer 60 made of organic semiconductor polymer, a layer 58 of heavily-doped transparent organic semiconductor polymer (electron donor layer), and a transparent electrode 56. A transparent protection coating 65 covers the upper surface of the array (on the side of electrodes 56).

Photodetectors 52 are here intended to be illuminated through protective coating 65 (and through transparent layers 56 and 58). In FIG. 6, the incident radiation is shown by arrows 69, on the side of transparent coating 65.

It is here provided to form device 50 by printing techniques. The materials of above-mentioned layers 56 to 65 are deposited in liquid form, for example, in the form of conductive and semiconductive inks by means of inkjet printers. It should here be noted that materials in liquid form here also means gel materials capable of being deposited printing techniques. Anneal steps may be provided between the depositions of the different layers, but the anneal temperatures cannot exceed 150° C., and the deposition and the possible anneals can be performed at atmospheric pressure.

The forming of organic semiconductor components by printing techniques is for example described in article “CEA-LITEN S2S printing platform for Organic CMOS and Sensors Devices” by Jean-Yves Laurent et al, LOPE-C Conference, June 2011, Frankfurt.

An advantage of device 50 is that it can be more easily formed than existing devices. In particular, it may be formed on a greater variety of surfaces, and particularly on larger surface areas and on any type of substrate, including on substrates having no resistance to heat, for example, flexible substrates made of plastic, paper, cardboard, fabric, etc. It should be noted that in the device of FIGS. 5A and 5B, if the substrate is opaque, upper electrode 62 may be made of a transparent conductive material, and the device may be illuminated on its front side (in the orientation of the drawing).

Further, device 50 may be formed by using equipment (printing deposition equipment) compatible with industrial package manufacturing equipment, plastics engineering, etc.

Another advantage of device 50 is that its cost is relatively low, since the equipment necessary for its manufacturing (printing deposition equipment) is less expensive than the equipment necessary to form inorganic semiconductor devices, and also less expensive than usual equipment used to form organic semiconductor components (low-pressure vapor deposition and high-temperature anneal equipment).

Various alterations, modifications, and improvements will readily occur to those skilled in the art. In particular, it will be within the abilities of those skilled in the art to provide any adapted stack of layers, other than those described in relation with FIGS. 5A, 5B, and 6, to form a photodetector. It may particularly use conductive, semiconductor, and dielectric materials capable of being deposited in liquid form, other than those mentioned hereabove.

More generally, it is provided to form touch or contactless user interface devices where semiconductor components are formed by deposition of liquid organic conductive and semiconductive materials on a dielectric support. Apart from the photodetector array, a display array (see FIG. 3) or infrared proximity sensors (see FIG. 4) may also be formed by printing of organic materials. A preferred application where the invention is particularly advantageous concerns devices of the type described in relation with FIGS. 1 to 4.

Further, although this has not been mentioned hereabove, it may be provided to have, in the photodetector array, one or several access transistors associated with each photodetector (active array). The transistors may also be formed from organic semiconductor materials in liquid or gel form, by printing techniques.

According to a third aspect of an embodiment of the present invention, an interactive display surface capable of being used, for example, for advertising purposes, is provided.

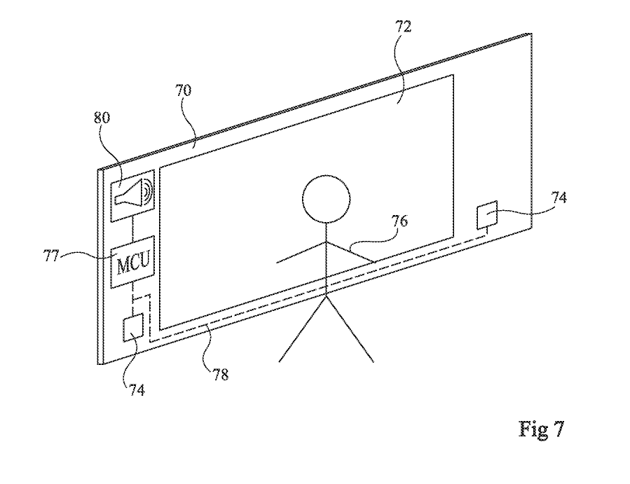

FIG. 7 is a perspective view schematically showing an embodiment of an interactive display surface 70.

Surface 70 comprises a display area (or screen) 72. The display area preferably has relatively large dimensions. Preferably, area 72 extends over a surface area greater than 3 m². Display area 72 is formed by deposition of organic conductive and semiconductive materials in liquid form on a dielectric support, by printing techniques. As an example, surface 70 is formed on a paper or plastic poster, on a glass shop window, on cardboard, or on fabric, etc. Such supports may be used as the dielectric support having display area 72 printed thereon. If need be, an interface dielectric layer may be deposited by printing on the support, for example, if the support is porous or does not have satisfactory dielectric properties. Display area 72 for example is an organic light-emitting diode screen. The forming of organic light-emitting diodes by printing techniques is for example described in above-mentioned article “CEA-LITEN S2S printing platform for Organic CMOS and Sensors Devices”. More generally, display area 72 may be formed in any other technology enabling to form a display screen by deposition of organic conductive, semiconductor, and dielectric materials in liquid form. As an example, area 72 may be made from light-emitting organic materials.

Surface 70 comprises at least one photosensitive presence detector 74 (two detectors 74 in the shown example). In this example, surface 70 is formed on a glass shop window, and detectors 74 are placed towards different ends of the shop window (bottom left-hand side and bottom right-hand side) and capable of delivering a signal when a passer-by 76 (user) or an object is in front of one or the other of these ends, in the detector range. Detectors 74 may be a simple photodiode or photoresistor, an infrared proximity detector, an array of photon sensors of the type described in relation with FIGS. 1 to 6, or any other photosensitive detector. In any event, detectors 74 are formed by deposition of organic conductive and semiconductive materials in liquid form on a dielectric support, by printing techniques.

A control unit 77 is provided to control display area 72 and have it display an animation (for example, an image, a slide-show, or a video) or, more generally, information, when sensors 74 detect the presence of a user in front of the shop window. Control unit 77 may be formed by discrete electronic components, or by integrated circuits (unit 77 for example comprises a microcontroller). Control unit 77 may be placed on surface 70, for example by gluing or embedding, or transferred and housed in a package external to surface 70. As a variation, control unit 77 may, like display area 72 and photosensitive sensors 74, be produced in printed organic electronics, directly on surface 70. Connections 78 between control unit 77, display area 72, and detectors 74, may be wireless or wired. Conductive tracks made of a transparent conductive material capable of being deposited in liquid form may for example be printed on surface 70.

In the shown example, a sound emission device 80, for example comprising one or several loudspeakers, is further provided. This enables to provide, apart from the visual animation displayed on display area 72, an audio animation. The audio device may be formed in any known technology, for example, based on piezoelectric materials. Device 80 may be placed on surface 70, for example, by gluing or embedding, or be external to surface 70. In a preferred embodiment device 80 is made of materials capable of being deposited in liquid form (for example, comprising an organic piezoelectric material), and directly formed on surface 70 by printing techniques.

For its electric power supply, interactive surface 70 may be connected to an electric power supply network (such as the mains) or to a battery. If the electric power supply needs of surface 70 are not too high, a battery made of materials capable of being deposited in liquid form, directly printed on surface 70, may be used.

As an example of use, an advertising device comprising a large interactive contactless surface may be provided (for example, in the order of several square meters), capable of starting the display of an animation as soon as a person (user) passes by the surface.

In an alternative embodiment, several presence detectors 74 may be provided at different points of surface 70. The control unit may then be programmed to vary the animation according to the user's position in front of the surface (multiple starts).

In another alternative embodiment, an array of photodetectors of the type described in relation with FIGS. 1 to 6 may be superimposed to display area 72. The photodetector array then plays the role of presence detectors 74. Such an embodiment enables to implement an interactive animation, that is, reacting to the user's actions (displacements, position changes, motions towards or away from the surface, etc.).

Various embodiments have been described, various alterations and modifications will occur to those skilled in the art.

In particular, the interactive display surface described in relation with FIG. 7 may be used for other applications than the animation of a shop window. More generally, such an interactive display surface may be used for any type of advertising or communication application. It will for example be within the abilities of those skilled in the art to adapt the provided operation to form interactive packages for commercial products (food products or others).

The practical implementation of the present invention is within the abilities of those skilled in the art based on the functional indications described hereabove and using technologies known per se.

1. A user interface device comprising an array of photon sensors, capable of detecting variations of the shadow of an actuating element and of deducing therefrom information representative of a distance variation between the actuating element and the sensor array.

2. The device of claim 1, capable of detecting variations of the light intensity level received by the sensors, and of deducing said information therefrom.

3. The device of claim 1, capable of deducing from the shadow variations information representative of a variation of the position of the actuating element parallel to the array of sensors.

4. The device of claim 1, comprising no optical system between the sensor array and the actuating element.

5. The device of claim 1, wherein a translucent protection layer coats the sensor array.

6. The device of claim 1, wherein the surface area of the sensor array is larger than the surface area of the actuating element opposite to said array.

7. The device of claim 1, wherein the actuating element is at a distance greater than ten centimeters away from the sensor array.

8. The device of claim 1, further comprising a light display pixel array.

9. The device of claim 1, wherein the photon sensors are made of transparent materials.

10. The device of claim 1, further comprising an infrared emitter array.

11. The device of claim 10, further comprising a darkness sensor and means for activating the infrared emitters when the brightness is lower than a threshold.

12. The device of claim 1, wherein the photon sensors are organic sensors formed by deposition of organic conductive and semiconductive materials in liquid form on a dielectric support.

13. The device of claim 12, wherein the dielectric support is made of a material from the group comprising glass, plastic, paper, cardboard, and fabric.

14. An interactive display surface comprising the user interface device of claim 12, and display means formed by deposition of organic conductive and semiconductive materials in liquid form on said dielectric support.

15. The method of manufacturing a device of claim 12, wherein said sensors are formed at a temperature smaller than 150° C. and at the atmospheric pressure.

16. An interactive display surface comprising the user interface device of claim 13, and display means formed by deposition of organic conductive and semiconductive materials in liquid form on said dielectric support.

17. The method of manufacturing a device of claim 13, wherein said sensors are formed at a temperature smaller than 150° C. and at the atmospheric pressure.
